(19) United States
(12) Patent Application Publication
(10) Pub. No.: US 2012/0260281 A1
(43) Pub. Date: Oct. 11, 2012

(54) SYSTEM AND METHOD FOR NETWORK LOCAL AFFILIATE TO USE AIRTIME ON A TELEVISION NETWORK IN A RETAILER LOCAL AFFILIATE OF A NATIONAL NETWORK SERVICE PROVIDER

(76) Inventors: Robert I. Wolinsky, Fairfield, CT (US); John Lunghi, Fairfield, CT (US); Glenn Becker, New City, NY (US)

(21) Appl. No.: 13/313,508

(22) Filed: Dec. 7, 2011

Related U.S. Application Data
(60) Provisional application No. 61/420,621, filed on Dec. 7, 2010.

(51) Int. Cl. H04N 21/236

(52) U.S. Cl. 725/36

(57) ABSTRACT

A system and method for managing airtime on an out-of-home television network may include partitioning out-of-home television network airtime between a national network service provider and retailer local affiliate. Unbooked airtime may be reserved for a booking agent. In response to identifying the booking agent, the booking agent may be enabled to book reserved airtime on the out-of-home television network. Airtime may be booked with content in response to receiving a booking request. The content may be uploaded and distributed for display on the out-of-home television network.

### RELATED APPLICATIONS

This Application claims priority to co-pending U.S. provisional patent applications Ser. No. 61/420,621 entitled “SYSTEM AND METHOD FOR NETWORK LOCAL AFFILIATE TO USE AIRTIME ON A TELEVISION NETWORK IN A RETAILER LOCAL AFFILIATE OF A NATIONAL NETWORK SERVICE PROVIDER” filed on Dec. 7, 2010, the contents of which are hereby incorporated by reference in their entirety.

### BACKGROUND

Advertising in retail environments has and will continue to increase. One form of advertising in retail stores is video advertising. There have been many different implementation attempts for video advertising in retail environments. One form of video advertising includes creating television metrics by forming a network of electronic displays within a retail environment such that shoppers become a television viewing audience through mathematical calculations, as described in U.S. patent application Ser. No. 12/368,232 filed Feb. 9, 2009, which is incorporated herein by reference in its entirety.

Despite such an out-of-home television network being created, one of the difficulties in operating the network is how airtime that is apportioned to a retailer (i.e., local airtime) is managed, where the apportionment of airtime is performed under an airtime partition scenario between a national network service provider and local affiliates, which are the retailers (e.g., grocery store retail chain), as further described in U.S. patent application Ser. No. 12/368,232. Because retailers are generally not established to manage media operations, the retailers have a need to find alternative solutions to manage and sell their apportioned airtime or local airtime.

Broadcast television networks for content distribution to in-home televisions have traditionally been established as a national network and local affiliates of the national network. For example, a television network, such as NBC®, includes a national network and local affiliates in different geographic areas, generally known as designated market areas (DMAs), that operate the broadcast network within respective geographic areas for distribution of the television network content to households in the local geographic area. Under this national network/local affiliate scenario, the television local network affiliate is apportioned airtime that can be sold, thereby allowing the television local network affiliate to make money. The local affiliates typically sell the airtime to local advertisers, such as automobile dealerships, but can also sell airtime to national advertisers, such as automobile companies that have a particular desire to target a local audience in a particular DMA.

As understood in the art, the audience size of in-home television is primarily based on programming content, such as a television show or movie selection, that draws the audience. The better the programming content, the larger the audience. Advertisers pay for impressions, where one impression is equivalent to one person who sees an advertisement. Audiences can vary for a wide variety of reasons. Advertisers normally buy airtime based on projected impressions (e.g., 2.3 million people projected to view a television show). However, when an audience shortfall occurs, the number of impressions is similarly reduced. As a result, the broadcast network, either the national network or local affiliate, has to compensate the advertiser by giving the advertiser free airtime to make up for the shortfall of impressions. Over time, if the number of impressions accumulate, the cost to the television network, either national network or local affiliate, can become quite large and expensive to compensate.

### SUMMARY

To provide retailers with the ability to manage and sell local airtime, the principles of the present invention provide for a television network local affiliate, or even television national network, of in-home television to become an airtime managing agency of a retailer local affiliate of out-of-home television. Because television networks have infrastructure to sell airtime, retailer network affiliates with out-of-home television networks in their retail stores may provide for television networks, such as local affiliates of television networks, to manage airtime of the retailer network affiliates. By doing so, a couple of problems for the television network local affiliates are solved, including (i) having a larger audience reach and (ii) being able to compensate advertisers for a shortfall of impressions at a lower cost than their own in-home television airtime. As an authorized agent of the retailer local affiliate, the television network local affiliate may reserve airtime or otherwise have airtime allocated so that the retailer local affiliate may later book content to be displayed on the airtime of the out-of-home television. In one embodiment, the airtime reserved is local airtime that was partitioned for use by retailer local affiliate, as compared to national airtime that is available for use by an out-of-home national network service provider. In another embodiment, if the television network local affiliate is to manage the local airtime on the out-of-home television network for a retailer network affiliate, then the television network local affiliate, which may be considered a booking agent, may have all of the local airtime reserved therefor, and place content in the local airtime for advertisers. A booking agent may also be an advertising agency that books airtime for advertisers.

A system and method for managing airtime on an out-of-home television network may include partitioning out-of-home television network airtime between a national network service provider and retailer local affiliate. Unbooked airtime may be reserved for a booking agent. In response to identifying the booking agent, the booking agent may be enabled to book reserved airtime on the out-of-home television network. Airtime may be booked with content in response to receiving a booking request. The content may be uploaded and distributed for display on the out-of-home television network.

### BRIEF DESCRIPTION OF THE DRAWINGS

For a more complete understanding of the present invention, reference is made to the following detailed description taken in conjunction with the accompanying drawings wherein:

FIG. 1A is an illustration of an illustrative map of the United States;

FIG. 1B is an illustration of an illustrative map of a designated market area (DMA);

FIG. 2 is an illustration showing two business models, one of a traditional television network and a second of an out-of-home television network;

FIG. 3 is an illustration showing a retailer local affiliate network with multiple retail chains having multiple retail chain stores;

FIG. 4 is an illustration of an aisle showing electronic displays suspended in a field-of-view of a shopper without the shopper having to alter their normal head position while shopping.

FIG. 5 is a table showing an illustrative airtime partition between an national network service provider and a retailer local affiliate;

FIG. 6 is a block diagram of an illustrative network that includes a network service provider server that is used to manage airtime of the network service provider (national avails) and airtime of retailer local affiliates (local avails);

FIG. 7 is a flow chart of a process for enabling airtime to be booked by a booking agent;

FIG. 8 is a screen shot of an illustrative user interface for enabling advertisers, agencies, retailer local affiliates, etc., to book or reserve airtime;

FIG. 9 is a screen shot of an illustrative user interface that allows for the television network local affiliate to reserve airtime; and

FIG. 10 is a screen shot of an illustrative user interface that allows for the television network local affiliate to book airtime that was previously reserved.

### DETAILED DESCRIPTION OF THE DRAWINGS

Television is more than an electronic display that displays video images. Television is both science and art. The science is the generation of audience delivery measurement metrics that television networks use to plan and predict audiences for selling to advertisers to reach the audiences with advertising content to promote their products. As in-home television has certain known metrics, an out-of-home video display network becomes television when measurement science is used to generate metrics that can be used to plan and predict audience viewership, as described in U.S. patent application Ser. No. 12/368,232 filed on Feb. 9, 2009, which is herein incorporated by reference in its entirety. In creating an out-of-home television network, content displayed on the electronic displays of the network may be synchronized so that, in a retail environment, customers traversing through the retail environment may view each advertisement a predictable number of times.

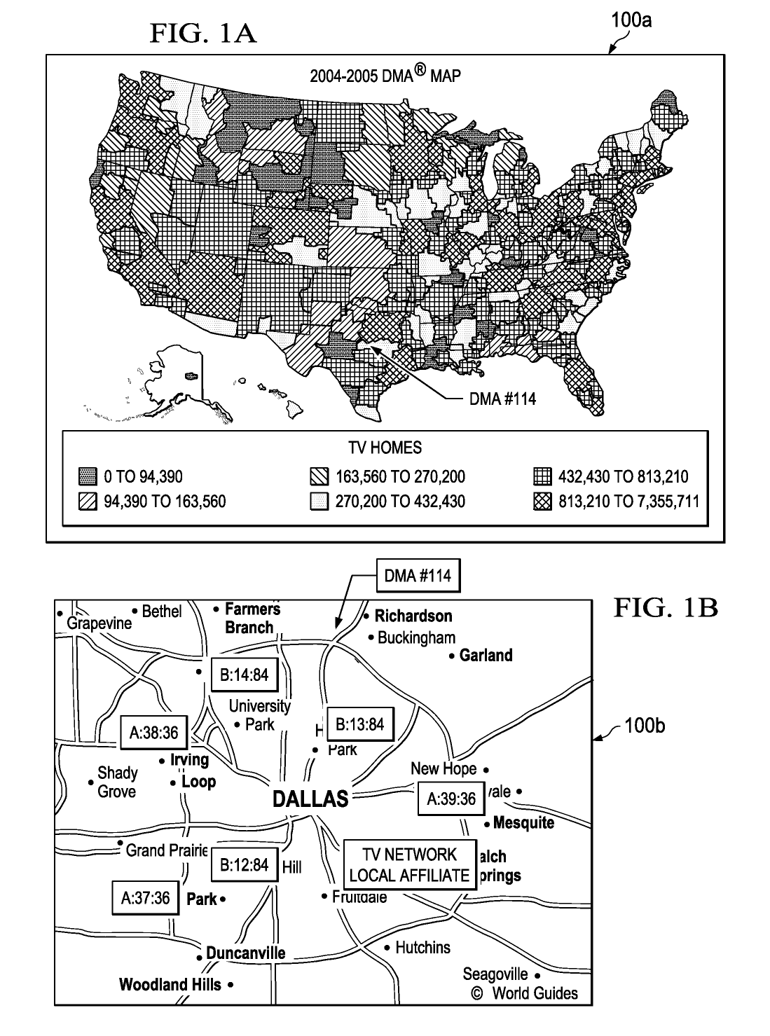

With regard to FIG. 1A, an illustration of an illustrative map 100a of the United States showing distinct DMAs is shown. There are currently 210 different DMAs in the United States. Advertisers generally desire to advertise to as many households within each DMA as possible. Advertisers generally use in-home television to achieve their goal of advertising to as many households within a DMA as possible. Alternative media, such as newspaper and Internet advertising, may be used to reach people in a DMA, but in-home television has traditionally been the most effective medium to reach a target audience.

As understood in the art, traditional television has a national network (e.g., NBC®) and network local affiliates in different designated market areas (DMAs). Non-programming airtime on a television network is partitioned generally to be 60% for the national network and 40% for the network local affiliate. Some networks operate on a 70%/30% airtime split or partition. As an example, for a 60%/40% airtime partition, if non-programming airtime is 20 minutes of every hour, then the national network is allocated 12 minutes and the network local affiliate is allocated 8 minutes. The partitioned airtime is typically sold to advertisers by each of the television national network and television network local affiliate, thereby generating revenue for the respective companies.

In accordance with the principles of the present invention, advertisers may reach household members by advertising on electronic display networks or out-of-home television within retail environments (e.g., grocery stores), which by some accounts, provides a larger audience and is more efficient than traditional in-home television as shoppers cannot fast-forward or change channels to avoid watching commercials as is so often done by viewers of in-home television. As shown in FIG. 1A, DMA 114 in North Texas, which includes the Dallas-Fort Worth Metroplex, may be targeted by advertisers through both traditional television broadcasting and broadcasting over electronic display networks within retail environments.

As shown in FIG. 1B, an illustrative map 100b of DMA 114 is shown. Within DMA 114, there are a number of different retail stores that are retailer local affiliates of a network service provider. The retailer local affiliates include retailer local affiliates A and B. Within DMA 114, local affiliate A has store numbers 37, 38, and 39, while local affiliate B has retail store numbers 12, 13, and 14. In addition, each of the retail stores have a certain number of total avails located therein. As shown, retailer local affiliate A, retail stores 37, 38, and 39 each have 36 total avails. It should be understood that the number of avails are the same as the store configurations are approximately the same and the shoppers that shop in each of the retail stores 37, 38, and 39 of retailer local affiliate shop for approximately the same average amount of time. Retailer local affiliate B, store numbers 12, 13, and 14 each have 84 avails, which means that the average shopping trip of shoppers in retailer B is longer than that of retailer A. In one embodiment, the average shopping trip in retail store A is 18 minutes, which may provide for a “wheel” of 36 advertisements of 10 seconds such that each shopper (reach) who shops the average shopping time has an opportunity to view each advertisement three times (frequency of view). Alternative wheel configurations, such as different length ad segments, different spacing time between ads, and so forth, may be utilized in accordance with the principles of the present invention. As further shown, the average shopping trip in retail store B is 42 minutes, so that the wheel length may be 14 minutes to enable each average shopper the ability to view each advertisement or message three times.

If the available airtime in each of the retail stores is partitioned between the national network service provider and the retailer local affiliate, then the retailer has a portion of the 36 avails to sell. In the case of the partition being 60%, then the retailer has 15 airtime segments and the national network service provider has 21 airtime segments. Rather than showing total avails (i.e., 36 and 84), it should be understood that total national avails and total local avails may be shown (e.g., 21 and 15; 51 and 33). Alternatively, rather than showing total avails, remaining avails, both national and local, may be shown in FIG. 1B. In one embodiment, the illustrative map 100b may be displayed on an interactive graphical user interface to allow the network service provider, local affiliate, and advertisers or their agencies to manage and/or advertise on the electronic display network of the network service provider within retail store environments. By being interactive, a user may select one or more retail stores to purchase either local or national airtime and submit content (e.g., advertisement) to the network service provider for distribution to the desired store(s) of local affiliate(s), as provided by FIG. 1A.

A television network local affiliate 102 is shown positioned within DMA #114. As such, the television network local affiliate 102 may become a manager, reseller, or user of airtime of the local airtime or local avails on the out-of-home television network operating in the retailer local affiliates' stores (i.e., local affiliate A stores 37-39 and/or retailer local affiliate B stores 12-14). Because the television network local affiliate 102 already has a market presence in the local area, the retailers A and/or B may be able to relinquish, at least in part, its burden for managing its airtime and in a way that may be more profitable (i.e., less costly) than other avenues.

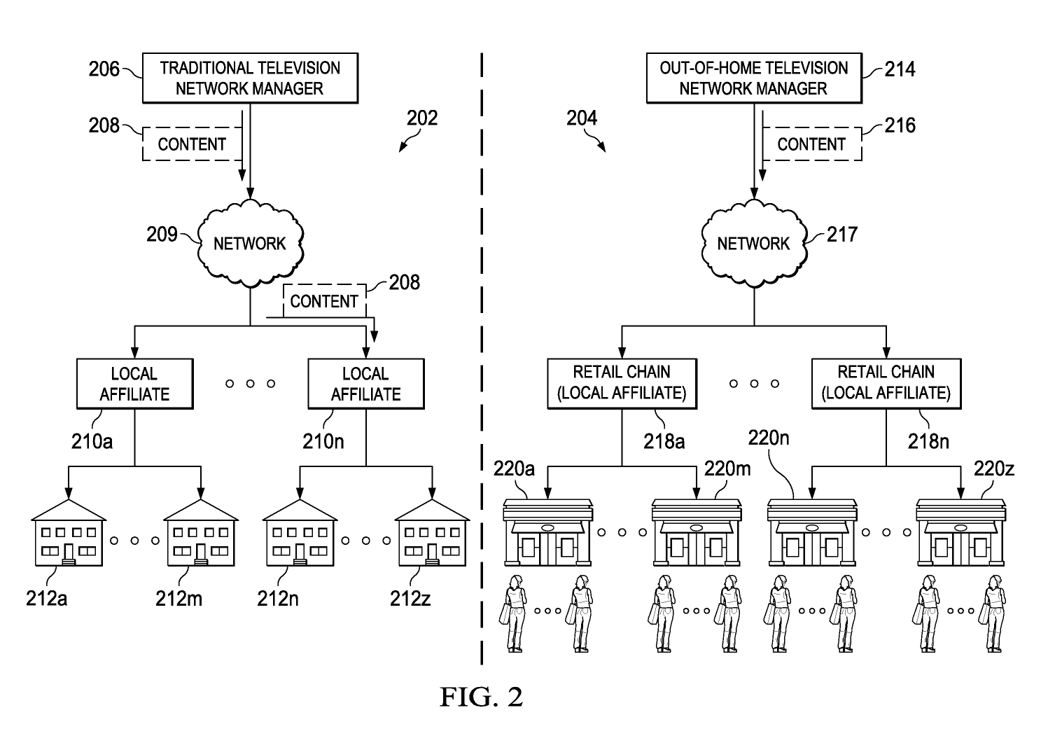

FIG. 2 is an illustration showing two business models, one of a traditional television network 202 and a second of an out-of-home television network 204. The traditional television network 202 includes a traditional television network manager 206 that communicates content 208 via a network 209 to local affiliates 210a-210n (collectively 210) to reach households 212a-212m and 212n-212z within one or more geographic regions. The out-of-home television network 204 includes an out-of-home television network manager 214 that distributes content 216, generally advertising content, via a network 217 to retailer local affiliates 218a-218n (collectively 218). Each of the retailer local affiliates 218a-218n has respective retail stores 220a-220m and 220n-220z in which the out-of-home television networks are operating.

Although the two television networks are shown as being independent from one another, an opportunity exists whereby television network local affiliates 210 are used to assist in selling or managing airtime for the retailer local affiliates 218. Since the television network local affiliates 210 have relationships with local advertisers, the television network local affiliates 210 can buy and sell local airtime of the retailer local affiliates 218 to local advertisers. As previously described, the television network local affiliates 210 may also be able to compensate advertisers for whom an under-delivery of impressions occurred on their own television network. In one embodiment, a single television network local affiliate in a geographic region (e.g., DMA) may be given exclusive rights for all of the retailer local affiliates 218 in the geographic region as guided by the out-of-home television network manager 214. Alternatively, the retailer local affiliates 218 may establish separate relationships with one or more television network local affiliates 210 based on geographic locations, service quality, price paid for airtime, or any other reason. The television network local affiliates 210 in a geographic region may bid on blocks of airtime, thereby increasing the price of the airtime that the retailer local affiliate receives for the airtime. It should be understood that a wide variety of contractual arrangements may be made with the television network local affiliates 210. The various contractual arrangements may be embodied in a computer software program to be executed on a computing system. In an alternative embodiment, as opposed to using a conventional contracting process for the airtime between the television network local affiliates 210 and the retailer local affiliate 218, the blocks of airtime may be sold to one or more television network local affiliates 210 using a bidding process via the Internet, for example. As a result of using a bidding process, the retailer local affiliates 218 and/or out-of-home television network manager 214 can let the market determine the value of the in-store television network airtime amongst the television network local affiliates 210.

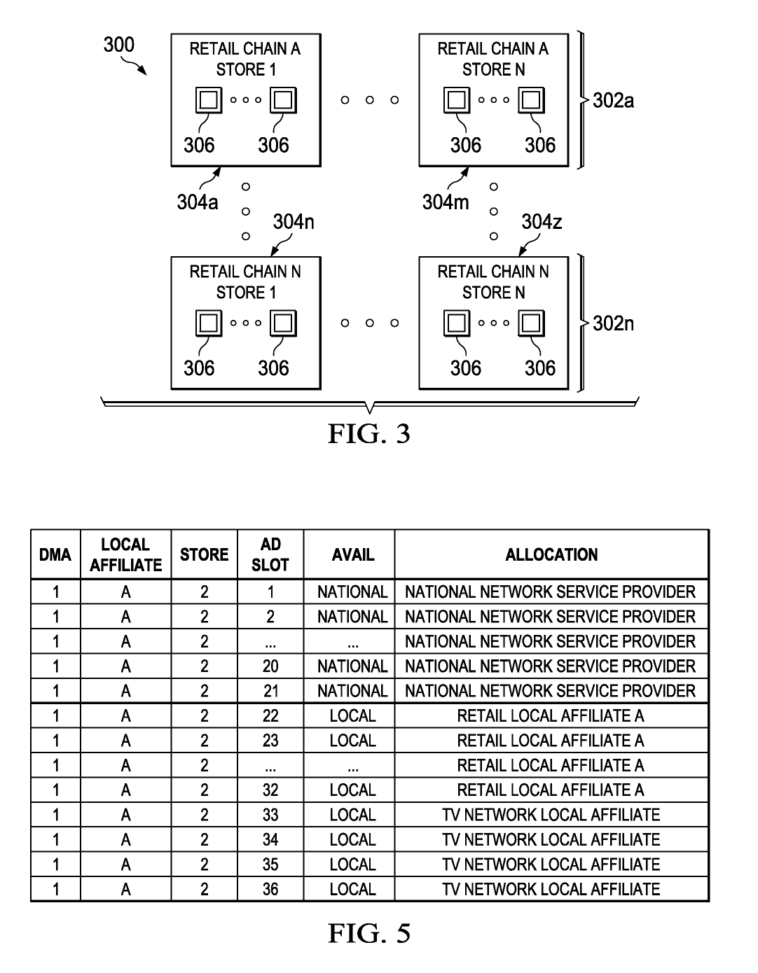

FIG. 3 is an illustration showing a retailer local affiliate network 300 with multiple retail chains 302a-302n having multiple retail chain stores 304a-304m and 304n-304z (collectively 304). The retail chain stores 304 each have multiple electronic displays 306 operating therein that provide for out-of-home or in-store media metrics that are consistent with traditional in-home television media metrics. By having the consistency, advertisers and agencies, including the television network local affiliates 210 of FIG. 2, readily understand the metrics without having to perform a significant conversion or paradigm shift.

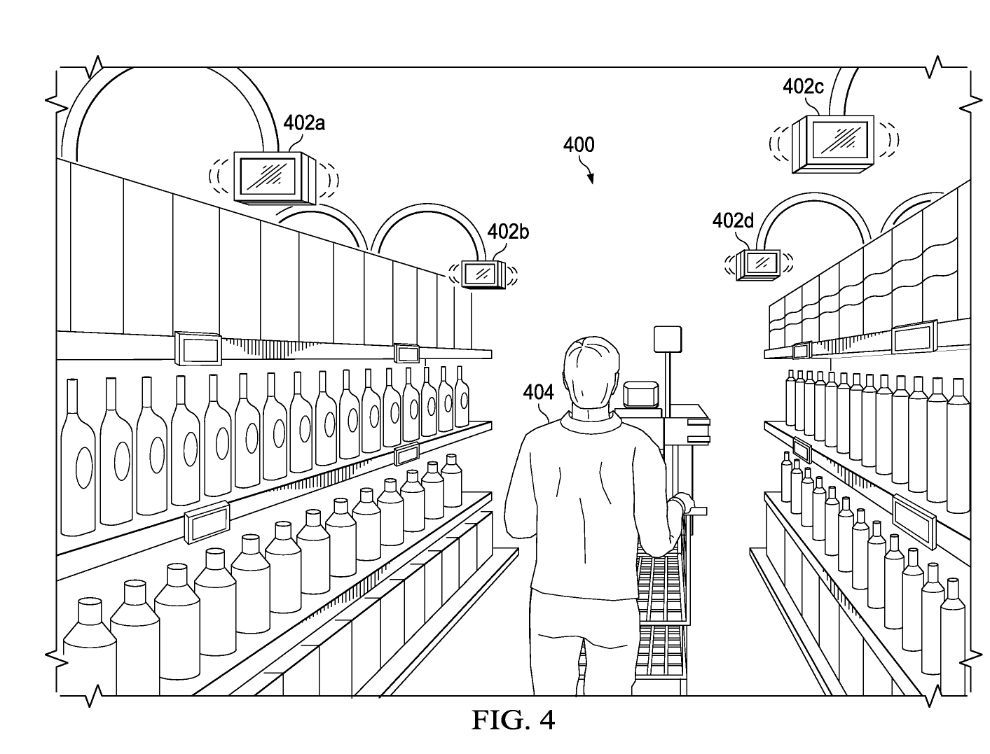

FIG. 4 is an illustration of an aisle 400 showing electronic displays 402a-402d (collectively 402) suspended in a field-of-view of a shopper 404 without the shopper 404 having to alter their normal head position while shopping. In other words, the electronic displays 402 are not positioned close to the ceiling such that the shopper 404 would have to actively tilt his or her head to see content being displayed on the electronic displays 402. The electronic displays 402 are separated by a distance that provides for a certain high percentage of shoppers (reach) to see each advertisement being displayed in a “wheel” a predictable number of times (frequency of view). The high percentage of shoppers may be 100%, but could be lower (e.g., 95%) if acceptable to advertisers. A configuration of the electronic displays 402 that provides for the media metrics is provided in co-pending U.S. patent application Ser. No. 12/368,232.

FIG. 5 is a table showing an illustrative airtime partition between an national network service provider and a retailer local affiliate. As shown, there are 36 total ad slots, where the national network service provider is allocated ad slots 1-21 and the retailer local affiliated is allocated ad slots 22-36. In this case, the retailer local affiliate has allocated four ad slots (i.e., ad slots 33-36) to a television network local affiliate. In one embodiment, the television network local affiliate purchases the block of airtime at a wholesale price, and may re-sell the airtime at a premium, use the airtime for selling as a supplement to its own television network local airtime, or use the airtime for compensating its advertisers for under-delivery of impressions. In an alternative embodiment, the television network local affiliate may be contracted by the retailer local affiliate or national network manager of the in-store television network to manage and sell local airtime on the in-store network. Whatever the arrangement, the table may show to what entity the airtime is allocated. If the television network local affiliate is to manage all of the local airtime, then the table may list the television network local affiliate in the allocation column. It should be understood that the table is illustrative and that the timeslots are representative of total number and not actual position within a “wheel.” It should further be understood that alternative configurations of the table may be utilized in providing for management of the airtime on the in-store television network.

As previously described, impressions of shoppers may have the same, higher, or lower value to impression value on traditional television and a compensation metric may be utilized in determining how much airtime in a retail store counts against airtime on in-home television. As an example, if an advertisement on television is 30 seconds, a 10 second advertisement on the retailer out-of-home television network trying to create the same impression may be determined to be less valuable. Alternatively, because the shopper is positioned to purchase a product where and when he or she sees the advertisement, albeit a shorter version, the impression may be determined to be more valuable to the advertiser. The compensation metric, therefore, may have a wide value range (e.g., 0.5 to 2.0). From the compensation metric, the television network local affiliate may use the number of impressions determined from the media metrics of the out-of-home television network to determine how to either set a price for resale of the airtime or how to determine compensation for the under-delivery of impressions that an advertiser is entitled.

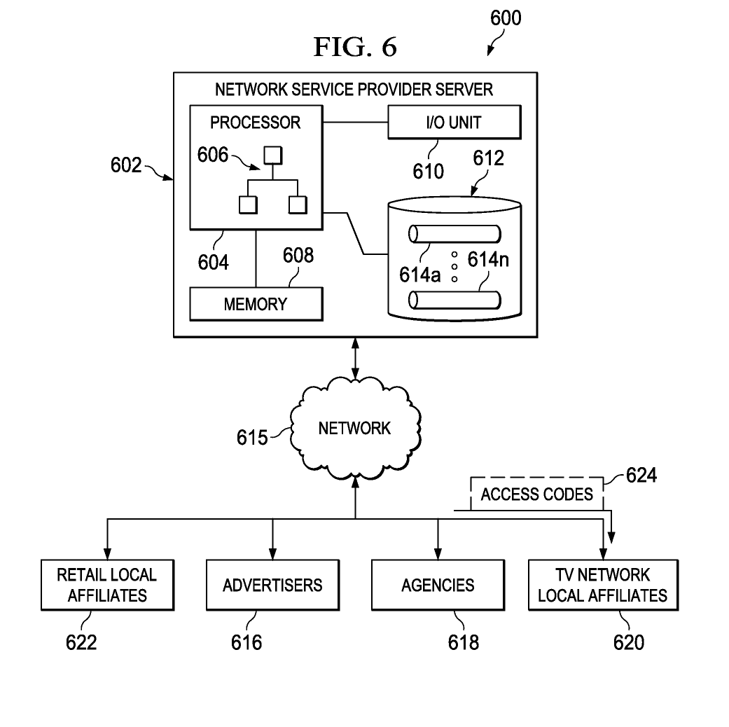

FIG. 6 is a block diagram of an illustrative network 600 that includes a network service provider server 602 that is used to manage airtime of the network service provider (national avails) and airtime of retailer local affiliates (local avails). The network service provider server 602 may include a processing unit 604 that executes software 606. The software 606 may be configured to handle management of the airtime, such as maintaining the table of FIG. 5 and/or supporting a graphical user interface that enables the airtime to be managed (e.g., purchase airtime and upload content). The processing unit 604 may be in communication with a memory 608, I/O unit 610, and storage unit 612. The memory 608 may be configured to store airtime information, such as shown in FIG. 5. The I/O unit 610 may be configured to communicate information over a communications network. The storage unit 612 may be configured to store data repositories 614a-614n for storing network information, including avails within retailer local affiliates (FIG. 5), content, playlists, website interface data, managers or booking agents of airtime (e.g., reserved airtime), and so on.

The network service provider server 602 may be in communication with network 615 for receiving airtime bookings from advertisers 616, agencies 618, and television network local affiliates 620. In addition, retailer local affiliates 622 may book airtime to promote their own products and stores. While the advertisers 616 may book national airtime (i.e., timeslots that are partitioned for the out-of-home network service provider), the advertisers 616 may book local airtime (i.e., timeslots that are partitioned for the retailer local affiliate), as well. Similarly, the agencies 618 may book national and local airtime. The television network local affiliates 620 and retailer local affiliates 622 primarily book local airtime. However, there may be occasions when the television network local affiliates 620 and retailer local affiliates 622 book national airtime.

To provide for booking the airtime, the network service provider server 602 may operate a website, extranet, virtual private network, or any other user interface by which airtime may be booked. In managing the airtime bookings, the network service provider server 602 may reserve the airtime in such a manner that a television network local affiliate is allocated airtime (see FIG. 5). In one embodiment, access codes 624 may be issued to television network local affiliates 620 that are authorized to book local airtime of retailer local affiliates. Alternatively, rather than being issued access codes 624, the network service provider server 602 may associate the reserved airtime for the television network local affiliates 620 based on user identifiers, such as an advertiser identifier, established by the network service provider or the television network local affiliates themselves. However the television network local affiliates 620 are identified, they may upload and book advertisements for their allocated local airtime on the out-of-home television network in the retailer local affiliate's stores.

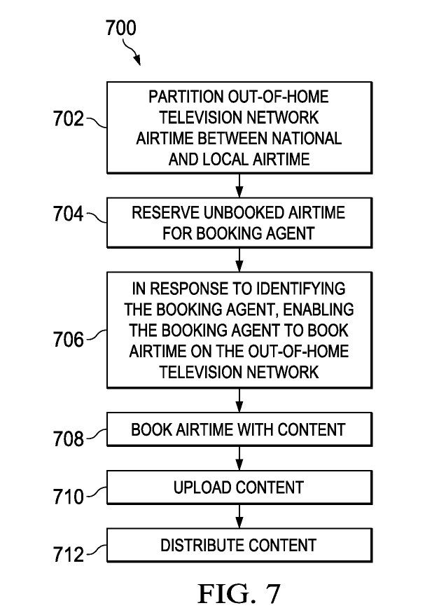

FIG. 7 is a flow chart of a process 700 for enabling airtime to be booked by a booking agent. The process 700 starts at step 702, where out-of-home television network airtime is partitioned between national and local airtime. The airtime may be partitioned 60% to the national network service provider and 40% to the retailer local affiliate. Other partitions may be utilized, as well. At step 704, unbooked airtime may be reserved for a booking agent. The booking agent may be a television network local affiliate. Alternatively, the booking agent may be a television national network. Reserving the airtime may be made by blocking or reserving the airtime (e.g., timeslots) and limiting access to booking the airtime to the booking agent. To block the airtime, the principles of the present invention may enable the booking agent to (i) buy the airtime and selectively reserve the airtime for later booking, (ii) reserve the airtime through a contract with either the national network service provider or retailer local affiliate, or (iii) or otherwise. If the airtime is reserved through contract, the national network service provider or retailer local affiliate may utilize a user interface to limit booking access to the booking agent.

At step 706, in response to identifying the booking agent, the booking agent may be enabled to book airtime on the out-of-home television network. In one embodiment, the principles of the present invention may issue an access code to the booking agent for submission when booking the airtime. Alternatively, a different technique for identifying the booking agent may be utilized. By identifying the booking agent, the blocked airtime may be controlled to avoid others from booking the reserved airtime. At step 708, airtime may be booked with content by the booking agent. In booking, the content may be uploaded to a server being utilized for managing and/or distributing content to retailer local affiliates with which the booking agent is authorized to place content on the out-of-home network and has reserved airtime. If multiple timeslots are reserved for the booking agent, the booking agent may book one or more timeslots for a single content segment to be displayed (e.g., two consecutive timeslots may be utilized by a single advertisement).

At step 710, the content may be uploaded. The uploaded content may be inserted into a playlist, incorporated into a “score” that blends music and content, modified to fit into a proper format, or be modified in any other way for use in displaying in a retailer local affiliate. At step 712, the content may be distributed to the retailer local affiliate for display thereat.

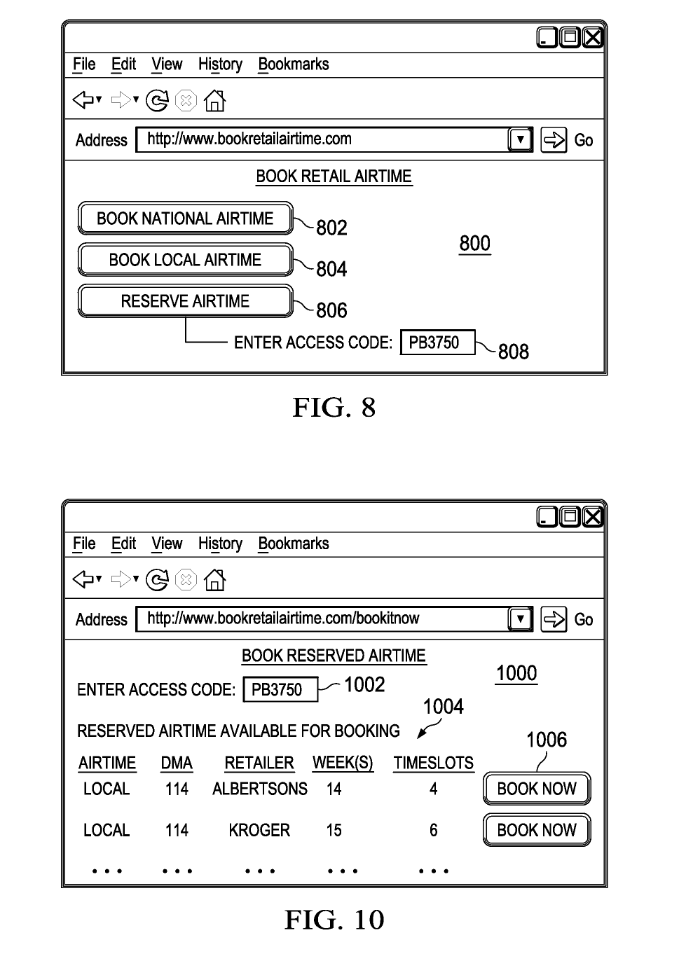

FIG. 8 is a screen shot of an illustrative user interface 800 for enabling advertisers, agencies, retailer local affiliates, etc., to book or reserve airtime. As shown, a user is able to book national airtime or local airtime for display of content on an out-of-home television network in a retail environment. To book national airtime across multiple, different retailer local affiliates, the user may select a “book national airtime” soft-button 802. To book local airtime within one retailer local affiliate, the user may select a “book local airtime” soft-button 804. In response to selecting either soft-button, a content submission and booking screen may be displayed that enables the user to select dates, duration, retail store(s), DMA(s), content for submission, etc. to book the desired airtime to display the submitted content. To reiterate, the national airtime is airtime or time slots on an out-of-home television network that operates within different retail environments (e.g., retail stores that are not part of the same corporate structure and otherwise not affiliated with one another). Local airtime is airtime on the out-of-home television network within a single retail environment (e.g., multiple retail stores in the same retail chain or affiliated stores). As previously described, each retail chain is a different retailer local affiliate and that the out-of-home television network that operates in different retail chains include national airtime for a national network service provider to use or sell airtime in each of the retail chains and local airtime for the respective retailer to use or sell. While it is desirable for many advertisers to purchase national airtime on the out-of-home television network throughout one or more designated market areas, it may not always be possible due to the availability limitations, financial constraints, demographic desires, or otherwise. With or without complete coverage in every retailer local affiliate in a DMA, it is generally expected that an advertisement in the national airtime is to be shown in national airtime across multiple retailer local affiliates within the DMA.

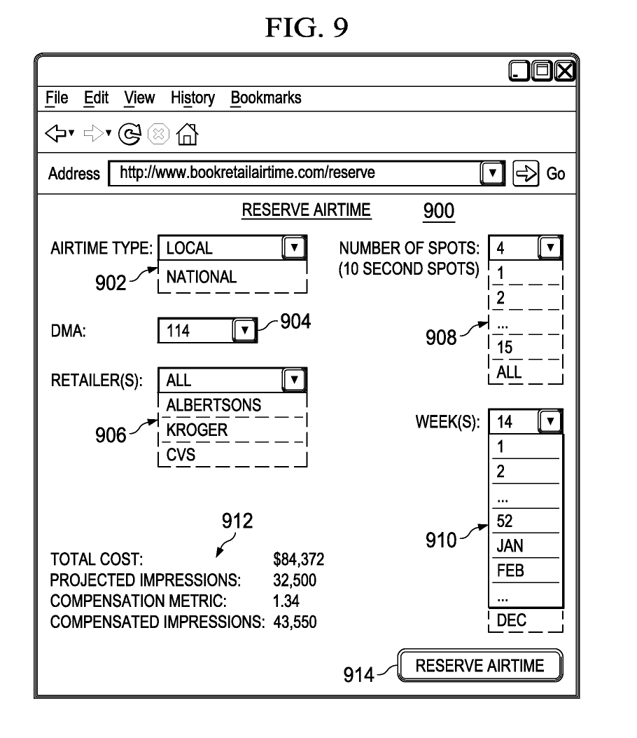

As further shown in FIG. 8, a “reserve airtime” soft-button 806 may cause an “enter access code” data field 808 to be displayed to enable the user to enter an access code (e.g., “PB3750”) in a data entry field 808 prior to reserving airtime. Rather than the user entering an access code, the system may generate a random or non-random access code for the user to enter when booking the airtime (i.e., submitting an ad for distribution and display in the selected retail environments). Alternatively, rather than having to submit an access code, a user name and password (not shown) may be used to access the booking and reserving screen in user interface 800. In response to the user entering the access code or in response to verifying authorization of the user by checking user name and password, for example, the user may be presented with a reserve airtime screen, as shown in FIG. 9. In an alternative embodiment, rather than the television network local affiliate reserving the airtime, the national network service provider or retailer local affiliate may reserve the local airtime on the out-of-home television network and assign an access code or other identifier that allows the television network local affiliate to access the system and book content during that reserved airtime (e.g., six 10-second timeslots during a given week).

The management of the airtime may be performed in a variety of different ways, including, but not limited to, (i) through a contractual relationship between the national network service provider and television network local affiliates to manage airtime for retailer local affiliates in specific designated market areas, (ii) through selling airtime (e.g., timeslots) to television network local affiliates on a temporary or long term basis, (iii) through an auction process for selling blocks of local airtime in one or more retailer local affiliate, or (iv) otherwise. Because the format of the airtime between the two different networks is generally different as in-home television networks generally use 30 second advertisements and retail television networks generally may use 10 seconds or less advertisements, a compensation metric, in one embodiment, may be utilized by the television network local affiliate as a way to better approximate and demonstrate to the advertiser that the shortfall of airtime is being properly accounted. If an in-home impression is determined to be the same as an out-of-home impression, then the compensation metric may be set to 1. However, if an out-of-home impression is determined to be more valuable than an in-home impression due to the person receiving the impression having the ability to immediately act and purchase a product in the retail store, then the compensation metric may be set higher than 1. Conversely, if a determination is made that the shorter length advertisements are less valuable to advertisers, then the compensation metric may be set to be less than 1.

The compensation metric may be factored based on retailer, geographic location, shopper demographic, product type, or otherwise, as well. For example, if the retailer is a grocery store and the advertiser sells food products, then the compensation metric may be set higher than 1. If, however, the advertiser sells sports gear, then the compensation metric may be set lower than 1. As another example, if the advertiser sells ski equipment and the retailer is located in a non-ski region (e.g., Texas), then the compensation metric may be set lower than 1. However, if the advertisement is placed in a ski region (e.g., Colorado), then the compensation metric may be set higher than 1, especially if the advertisement is placed in a store of a retailer local affiliate that sells the advertiser's ski products.

The compensation metric may be set based on business rules that are acceptable to the advertisers and television network local affiliates that are using the out-of-home television network to compensate advertisers for impression shortfalls. The business rules may include a comparison between the in-home television network that is reserving the airtime on the out-of-home television network as compared to the airtime that the in-home television network delivers. It should be understood that the business rules that are applied may be subjective and/or objective and that the compensation metric may vary over time based on relative strength, for example, of the respective different television networks or from airtime reservation to airtime reservation based on a variety of factors, as exemplified above. It should be understood that each television network may have different compensation metrics due to strength or weakness of their own television networks, such as having low impressions as compared to the out-of-home television network in a DMA or having different viewership demographics. For example, the Fox News® television network may have a different compensation metric than the ABC® television network. It should also be understood that a distributor of multiple television networks may operate as a television local affiliate. In one embodiment, when the television network local affiliate is reserving airtime, the compensation metric may be determined (e.g., looked up in a database and/or calculated by a computer based on one or more of the factors described herein) and presented to the booking agent (i.e., retailer local affiliate), such as shown in FIG. 9. The compensation metric may be determined by a computing system that uses a lookup table to access compensation metrics for individual airtime purchase input parameters in response to a user submitting the airtime purchase input parameters. The airtime purchase input parameters may include product type, DMA, television network, retailer, and so forth.

FIG. 9 is a screen shot of an illustrative user interface 900 that allows for the television network local affiliate to reserve airtime. In one embodiment, the user interface 900 may enable the television network local affiliate, other agent, national network service provider, or retailer local affiliate to select whether to reserve local or national airtime using a selection user element 902. It should be understood that national and local airtime is both available in a local geographic area, but that national airtime is reserved for the national network service provider across multiple retailer local affiliates and the local airtime is reserved for each of the retailer local affiliates. Selection element 904 may allow a user to select one or more DMAs in which the airtime is to be reserved. It should be understood that other user interface elements may be used to enable the user to select the DMA(s). A retailer selection element 906 may enable a booking agent select one or more retailers in which to reserve airtime. The booking agent may also select number of spots via a selection element 908 to book time frames, such as week(s), during which the airtime is to be booked using selection element 910.

In response to the selecting the airtime type, DMA(s), retailer(s), number of spot(s), and week(s), a total cost, projected impressions, compensation metric, and compensated impressions may be computed and displayed in display region 912. It should be noted that the compensated impressions may cause the number of impressions to be scaled upward or downward depending on a number of different factors, as described above. The television network local affiliate may use the impressions, projected, compensated, actual, or compensated actual, to present to the advertiser to show a current balance of impressions. If the number of retail impressions exceeds the number of owed impressions, then the balance may be a negative balance to the advertiser with the television network local affiliate, which may be used to adjust for later shortfalls of impressions through advertisements placed on the television network local affiliate's channel(s). As an example, if the television network local affiliate has a shortfall of 35,000 viewers due to low ratings for a television show, then the television network local affiliate may book airtime for the advertiser's advertisement on a retailer local affiliate's airtime, which may result in 32,000 actual or compensated actual impressions to occur, thereby resulting in a balance of 3,000 remaining impressions.

TABLE 1 shows a list of advertisers and impression balances with a television network local affiliate. The list further shows a list of compensation impressions that the television network local affiliate has achieved via the out-of-home television network. In one embodiment, the out-of-home national network service provider may maintain the list using a server on which the television network local affiliate reserves and books airtime. Alternatively, the television network local affiliate may receive the out-of-home compensated actual impressions (or actual impressions) and enter the information to manage the advertiser impression balance list.

TABLE I

| | | | Out-of-Home | Current |
|---|---|---|---|---|
| | | Advertiser | Compensated | Advertiser |
| | | Impression | Actual | Impression |
| As Of Date | Advertiser | Balance | Impressions | Balance |
| Dec. 1, 2010 | ABC | 284,281 | 220,000 | 64,281 |
| Dec. 6, 2010 | XYZ | 47,847 | 32,000 | 15,847 |
| . . . | . . . | . . . | . . . | . . . |

FIG. 10 is a screen shot of an illustrative user interface 1000 that allows for the television network local affiliate to book airtime that was previously reserved. The user interface 1000 limits the ability for booking the airtime to that airtime that was reserved. The user may enter an access code into a text entry field 1002. In response, a list 1004 of reserved airtime available for booking may be displayed. The list may include all reserved airtime that is associated with the access code. It should be understood that the access code may be associated with each individual airtime reservation or may be associated with multiple or all airtime reservations. In one embodiment, each retailer local affiliate may assign unique access codes for reserving that retailer local affiliate's airtime, so that the listed reserved airtime will be limited to each individual retailer local affiliate (e.g., Albertsons). If the user is ready to book the airtime, then the user may select a “book now” soft-button 1006 to begin the booking process, which includes uploading content to be displayed during one or more timeslots.

Although the principles of the present invention have been described using retailers as local affiliates, it should be understood that retailers may include any venue that is capable of providing out-of-home television with media or television metrics that are compatible in-home media or metrics. Being compatible means that advertisers consider the metrics to provide a certain number of impressions that can be determined either equivalently or through compensation to match or be acceptably close for advertisers to those metrics that an in-home television network provides.

The previous detailed description of a small number of embodiments for implementing the invention is not intended to be limiting in scope. One of skill in this art will immediately envisage the methods and variations used to implement this invention in other areas than those described in detail.

We claim:

1. A method for managing airtime on an out-of-home television network, said method comprising:
partitioning out-of-home television network airtime between a national network service provider and retailer local affiliate;
reserving unbooked airtime for a booking agent;
in response to identifying the booking agent, enabling the booking agent to book reserved airtime on the out-of-home television network;
booking airtime with content in response to receiving a booking request;
uploading the content; and
distributing the content for display on the out-of-home television network.

2. The method according to claim 1, wherein reserving unbooked airtime includes reserving local airtime of the retailer local affiliate.

3. The method according to claim 1, wherein identifying the booking agent includes receiving an access code associated with the airtime and booking agent.

4. The method according to claim 1, further comprising setting a compensation metric and using the compensation metric to compute a compensated impressions value.

5. The method according to claim 4, wherein setting the compensation metric includes computing a compensation metric.

6. The method according to claim 6, wherein computing the compensation metric includes using business rules in the computation.

7. The method according to claim 1, further managing an impression balance list that includes a current impression balance for an advertiser.

8. The method according to claim 7, further comprising offsetting a current impression balance with impressions delivered by an out-of-home television network and displaying the offset current impression balance.

9. The method according to claim 8, wherein offsetting a current impression balance with impressions includes offsetting the current impression balance with compensated actual impressions, and displaying the offset current impression balance.
